(19) United States
(12) Patent Application Publication
(10) Pub. No.: US 2013/0310961 A1
(43) Pub. Date: Nov. 21, 2013

(54) ADDITITVE MANUFACTURING OF COMPONENTS FOR DOWNHOLE WIRELINE, TUBING AND DRILL PIPE CONVEYED TOOLS

(71) Applicant: SCHLUMBERGER TECHNOLOGY CORPORATION, (US)

(72) Inventor: JUAN CARLOS INTRIAGO VELEZ, HOUSTON, TX (US)

(73) Assignee: SCHLUMBERGER TECHNOLOGY CORPORATION, SUGAR LAND, TX (US)

(21) Appl. No.: 13/834,103

(22) Filed: Mar. 15, 2013

Related U.S. Application Data
(60) Provisional application No. 61/637,062, filed on May 15, 2012.

(51) Int. Cl. G06F 17/50

(52) U.S. Cl. CPC G06F 17/50
USPC 700/97

(57) ABSTRACT

Additive manufacturing may be used to manufacture components of downhole tools conveyed by downhole wireline, tubing, drill pipe and/or the like. A method in accordance with one or more aspects of the disclosure uses starting materials to incorporate one or more feedthroughs, passages, channels, chambers and the like in a downhole tool structure during the formation of the structure. A CAD may be made and then converted to a STL file, and then stereo lithography, selective laser sintering, fused deposition modeling, direct metal laser sintering and/or electron beam melting may be used to form the downhole tool. Subtractive manufacturing may be performed on the downhole tool after the downhole tool is formed by additive manufacturing.

### CROSS-REFERENCE TO RELATED APPLICATIONS

This application claims priority to U.S. Provisional Application 61/637,062 filed May 15, 2012, the entirety of which is incorporated herein by reference.

### FIELD OF THE INVENTION

Aspects relate to manufacturing of industrial components. More specific aspects relates to a methodology for manufacturing parts, tools, instruments, components and equipment.

### BACKGROUND INFORMATION

The methodology for manufacturing parts, tools, instruments, components or equipment has may entail an assembly or construction process. In the case of metallic apparatus, the parts have traditionally been formed in a casting or founding process. In the oil and gas industry, for example, tools for downhole use are formed as metallic cylinders that are used to house various types of sources, sensors, measurement equipment, sampling chambers, transmitters and the like.

For example, downhole tools are used in drilling wells, investigating the subsurface formation properties, monitoring well conditions, and production of hydrocarbons from the well. For example, in well logging or monitoring, a downhole tool having emitting sources and sensors for measuring various parameters may be lowered into a borehole on the end of a cable, a wireline, a tubing string, or a drill string. The downhole tool is designed to withstand the harsh environments downhole which may include temperatures of 250° C. or higher and pressures of 25,000 psi or higher.

FIG. 1 depicts an example of a conventional downhole electromagnetic logging tool equipped with transducers. The transducers 30 may be mounted in a downhole tool 100 which is disposed in a borehole 12 that penetrates an earth formation. The downhole tool 100 may include a multi-axial electromagnetic antenna 91 for subsurface measurements and may include electronics 92, 93 with appropriate circuitry. The downhole tool 100 is shown supported in the borehole 12 by a logging cable 95 in the case of a wireline system or a drill string 95 in the case of a while-drilling system. With a wireline application, the downhole tool 100 may be raised and lowered in the borehole 12 by a wench (not shown) which is controlled by surface equipment 98. The logging cable or drill string 95 may include conductors 99 that connect the downhole electronics 92, 93 with the surface equipment 98 for signal and control communication. Alternatively, these signals may be processed or recorded in the downhole tool 100, and the processed data may be transmitted to the surface equipment 98 using any means known in the art.

The electronics 92, 93 may be mounted in the downhole tool 100 using various techniques known in the art. Electrical leads may be routed as desired using electronics modules or multiplexers that may drive long cables. conventional electronics, linking components such as fiber optics, and connectors may be used within the downhole tool 100, as known in the art.

A common method for routing wiring, hose, cabling and the like within a downhole instrument is by drilling or machining a series of passages within the housing walls of the downhole tool 100. With this methodology, a more complex system requires more complex routing and multiple passages to make elaborate turns or form desired angles within the wall or body of the structure. As a result, complicated machining and assembly may be required to form the passages enclosed by the tool 100.

FIG. 2 depicts a side cross-section view of an embodiment of the downhole tool 100 which includes a transducer 200. The transducer 200 is positioned in a recess 312 formed in a wall of the downhole tool 100. The transducer 200 may be coupled to a bulkhead 310 that ties into a passage 313 for signal/power transmission between the transducer 200 and external components, such as electronics, telemetry, memory, and the like, via one or more leads 314 as known in the art. A shield 316 may cover the transducer 200.

Electronics and sensors have wires and cables that necessitate the machining or drilling of passages in tool bodies. However, the need for conduits or channels are not unique to electronics and sensors. Many downhole tools handle fluids, including drilling fluids, well treatment or stimulation fluids, and formation fluids. These tools also need passages for fluid communications. For example, a formation tester used to investigate reservoir pressures and permeabilities obtains formation fluid samples for analysis.

FIG. 3 shows a cut-away view of a formation tester embodiment of the downhole tool 100 deployed in a borehole 14. The downhole tool 100 is provided with various modules and/or components, such as a fluid sampling device 26 used to obtain fluid samples from the subsurface formation 19. The fluid sampling device 26 may be provided with a probe 28 extendable through the mudcake 15 and to a sidewall 17 of the borehole 14 for collecting samples. The samples may be drawn into the downhole tool 100 through the probe 28. The sampling system 26 may include an intake section 25 and a flow section 27 for selectively drawing fluids into the desired portion of the downhole tool 100. The probe 28 may be mounted on an extendable base 30 which may have a seal 31, such as a packer, for sealingly engaging the sidewall 17 of the borehole 14 around the probe 28. Extension pistons 33 may selectively extend the probe 28 from the downhole tool 100.

The probe 28 may be provided with an interior channel 32 and an exterior channel 34 separated by a wall 36. The wall 36 may be concentric with the probe 28. However, the geometry of the probe 28 and the corresponding wall 36 may be any geometry. Additionally, any number of the walls 36 and any configuration of the walls 36 within the probe 28 may be implemented.

The flow section 27 may include a first flow line 38 in fluid communication with the interior channel 32 and may include a second flow line 40 in fluid communication with the exterior channel 34. One or more pumps 36 may drive the first flow line 38 and the second flow line 40. The flow section 27 may include one or more flow control devices, such as the pump 35 and valves 44, 45, 47 and 49, for selectively drawing fluid into various portions of the flow section 27.

Fluid may be drawn from the formation, through the channels 32, 34 and into their corresponding flow lines. Contaminated fluid may be passed from the formation through the exterior channel 34 into the second flow line 40 and discharged into the borehole 14. Fluid may pass from the formation into the interior channel 32, through the first flow line 38 and diverted into one or more sample chambers 42 or discharged into the wellbore. After the fluid passing into the first flow line 38 is determined to be virgin fluid, one or more of the valves 44, 49 may be activated by manual and/or automatic operation to divert fluid into the sample chamber.

The fluid sampling device 26 may also include one or more fluid monitoring systems 53 for analyzing the fluid as it enters the probe 28. The fluid monitoring system 53 may include various monitoring devices, such as optical fluid analyzers.

The systems shown in FIGS. 1-3 merely represent examples of the many systems and devices that are disposed in conventional downhole tools. These configurations generally require the formation of voids, passages, chambers, tunnels and openings within the tool body or portions thereof. As technology advances in the field of manufacturing, the construction and formation of tools and apparatus become more mechanized.

### SUMMARY

In one example embodiment, a method for manufacturing downhole component is disclosed comprising designing a component with a computer program, wherein the designing of the component generates a CAD file;

converting the CAD file to a STL file; initiating manufacture of the downhole component using an additive manufacturing technique; finishing the downhole component with the additive manufacturing technique.

In another example embodiment, the method maybe accomplished to further comprise machining the finished downhole component.

In another example embodiment, the method may be accomplished wherein the finishing the downhole component is performed using at least one of sanding, sand blasting and bead blasting.

In another example embodiment, the method may be accomplished, wherein the machining the finished downhole component is achieved by at least one of a CNC machine and a lathe.

In another example embodiment, the method may be accomplished such that the method further comprises inspecting the downhole component after the finishing the downhole component with the additive manufacturing technique.

In another example embodiment, the method may be accomplished such that the initiating the manufacture of the downhole component using an additive manufacturing technique is through selective laser sintering.

In another example embodiment, the method may be accomplished such that the initiating the manufacture of the downhole component using an additive manufacturing technique is through fused deposition.

In another example embodiment, the method may be accomplished wherein the initiating the manufacture of the downhole component using an additive manufacturing technique is through stereo lithography.

In another example embodiment, the method may be accomplished wherein the initiating the manufacture of the downhole component using an additive manufacturing technique is through electron beam melting.

### BRIEF DESCRIPTION OF THE DRAWINGS

FIG. 1 generally illustrates a prior art electromagnetic logging tool disposed in a borehole.

FIG. 2 shows a cross section of a prior art downhole tool illustrating a transducer disposed in a chamber created in a section of the tool body.

FIG. 3 shows a prior art downhole fluid sampling tool disposed in a borehole.

FIG. 4 generally illustrates a flow chart of a method in accordance with one or more aspects of the present disclosure.

FIG. 5 generally illustrates a prior art downhole tool manufactured using traditional subtractive manufacturing.

FIG. 6 generally illustrates en example of a downhole tool manufactured according to one or more aspects of the present disclosure

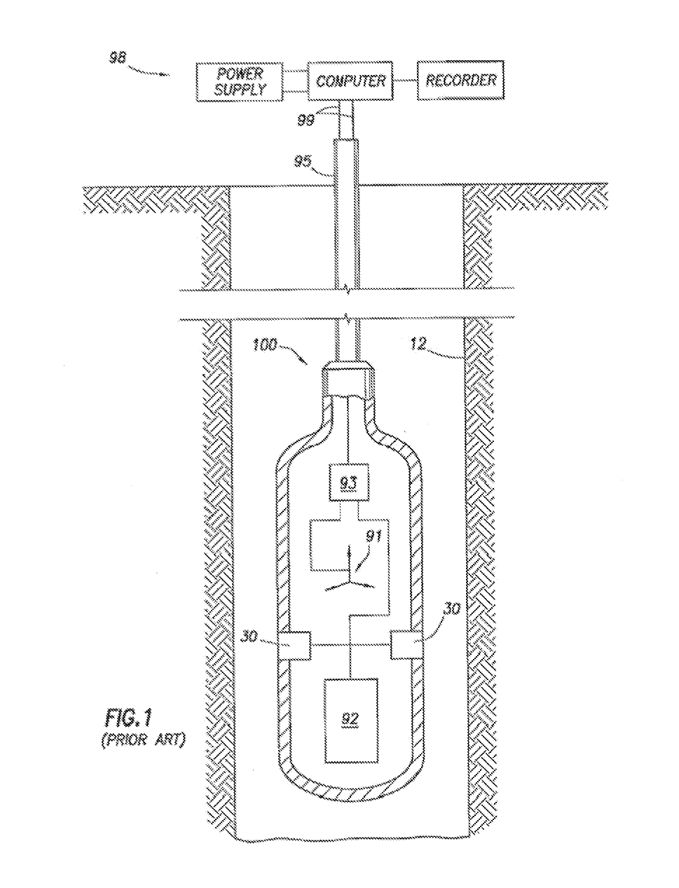

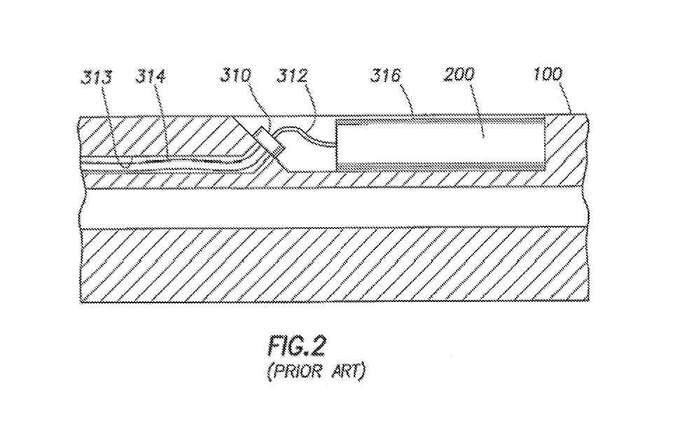

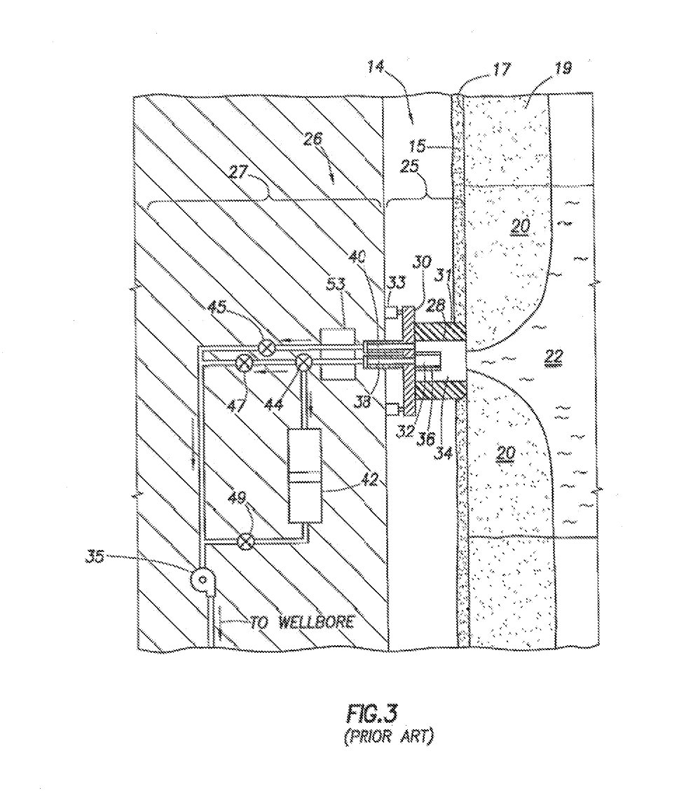

### DETAILED DESCRIPTION

The present disclosure generally relates to a method of manufacturing a component. While the disclosure details a manufacturing method related to an oilfield tool, a person having ordinary skill in the art will appreciate that the teachings of the disclosure are applicable to many industries outside the oilfield industry.

The present disclosure sets forth example embodiments for using additive manufacturing to manufacture components of downhole tools conveyed by downhole wireline, tubing, drill pipe and/or the like. A method in accordance with one or more aspects of the disclosure, uses starting materials to incorporate one or more feedthroughs, passages, channels, chambers and the like in a downhole tool structure during the formation of the structure. Downhole tool is used herein to include a portion of a tool or a complete tool that may be used in or about a wellbore or wellsite.

Stereo lithography (SLA), selective laser sintering (SLS), fused deposition modeling (FDM), direct metal laser sintering (DMLS) and/or electron beam melting (EBM) may be used to manufacture parts for downhole formation evaluation and testing tools, which include, but are not limited to, wireline tools, production logging tools, coiled tubing tools and measurement-while-drilling tools.

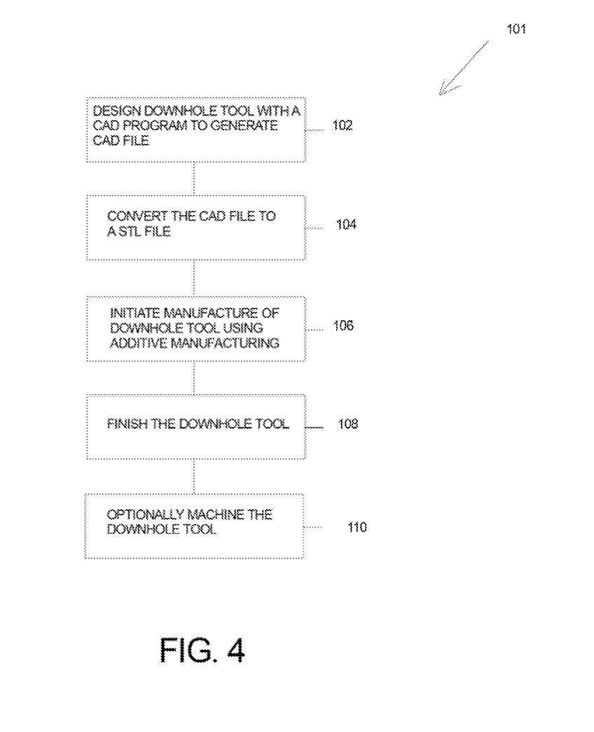

FIG. 4 generally illustrates a method 101 in accordance with one or more aspects of the present disclosure. The method 101 may be performed by a processor, a controller and/or any other suitable processing device. For example, a processing device may perform the method 101 by executing coded instructions stored on a tangible machine and/or computer-readable medium, such as a flash memory, a CD, a DVD, a floppy disk, a read-only memory (ROM), a random-access memory (RAM), a programmable ROM (PROM), an electronically-programmable ROM (EPROM), and/or an electronically-erasable PROM (EEPROM), an optical storage disk, an optical storage device, a magnetic storage disk, a magnetic storage device, and/or any other tangible medium which may be accessed, read and/or executed by a processing device. Moreover, one or more of the portions of the method 101 may be implemented manually based on user input, and one or more of the portions of the method 101 may be implemented automatically without user input.

At 102, a downhole tool may be designed. The design of the downhole tool may be optimized using additive manufacturing processes using 3D computer aided drafting software, such as Computer-Aided Design (CAD). As known to one having ordinary skill in the art, additive manufacturing involves positioning successive layers of material.

Complex geometries, such as non-linear curves, surfaces and other features, may be used to reduce the size, the weight and/or the volume of the downhole tool. For example, flowlines extending through hydraulic blocks may be routed in non-linear paths around other features, such as valves, probes, and sampling chambers in the hydraulic blocks, to decrease the length and/or the weight of the flowlines. Such flowlines may be formed without gun drilling techniques and/or without connections formed by plugs. In some embodiments, the weight of the downhole tool may be decreased by routing internal passages away from surfaces so that one or more surfaces may contour toward the internal passages and may use less material. Additional considerations may be used when designing features of the downhole tool, such as threads and sealing surfaces, and extra material may be added in the CAD model to enable post-machining of these features. Datum features, namely non-solid features used in the construction of other features, may be included to allow for proper indexing to enable post-machining. Example datum features are planes, axes, coordinate systems, and curves.

After a design of the downhole tool is optimized for manufacturing using additive processes, the CAD file may be converted into a Standard Tessellation Language (STL) file at 104. The STL file may describe a raw unstructured triangulated surface by the unit normal and vertices ordered by the right-hand rule of the triangles using a three-dimensional Cartesian coordinate system. The STL file may be a binary file or an ASCII file. The STL file may be used for an additive manufacturing system as discussed in more detail hereafter. The STL file may be created using a relatively high resolution and then may be opened using the CAD software used in 102 to verify the integrity of the STL file.

After the STL file is verified, manufacture of the downhole tool may be initiated using additive manufacturing in 106. The downhole tool may be formed using stereo lithography, selective laser sintering, direct metal sintering, fused deposition modeling and/or electron beam melting. The downhole tool may be formed using a relatively high resolution. The additive manufacturing may be performed using any means of additive manufacturing known to one having ordinary skill in the art, and manufacture of the downhole tool is not limited to a specific means of additive manufacturing.

Stereolithography may involve using liquid ultraviolet curable photopolymer resin and an ultraviolet laser to build layers one at a time. For each layer, the laser beam may trace a cross-section of the part pattern on the surface of the liquid resin. Exposure to the ultraviolet laser light may cure and/or may solidify the pattern traced on the resin and may join the pattern to the layer below. After the pattern is traced, an elevator platform may descend by a distance equal to the thickness of a single layer, such as 0.05 mm to 0.15 mm, for example. Then, a resin-filled blade may traverse the cross-section of the part to re-coat the cross-section with fresh material. The subsequent layer pattern may be traced on the fresh material to join the previous layer. These steps may be repeated until the downhole tool is completed. Then, a chemical bath may be used to clean the downhole tool of excess resin, and the downhole tool may be cured in an ultraviolet oven.

Selective laser sintering may involve using a high power laser, such as a pulsed carbon dioxide laser, to fuse particles of plastic, metal, ceramic, and or glass into a mass that has the desired 3-dimensional shape. Selective laser sintering using metal particles is known to one having ordinary skill in the art as direct metal sintering. The laser may selectively fuse the particles by scanning cross-sections generated from the STL file on the surface of a powder bed. After each cross-section is scanned, the powder bed may be lowered by the thickness of one layer, and a new layer of material may be applied on top. These steps may be repeated until the downhole tool is completed.

Fused deposition modeling may involve dispensing a first material for the downhole tool and a second material for a disposable support structure. Thermoplastics may be liquefied and may be deposited by an extrusion head which may follow a path defined by the STL file. The materials may be deposited in layers so that the downhole tool is built one layer at a time. Melted beads of thermoplastic material may be extruded to form layers, and the thermoplastic material may harden after extrusion.

Electron beam melting may involve slicing the model into a series of two-dimensional layers having a thickness less than 1 mm, ranging from 0.05-0.2 mm. An electron beam, such as, for example, a 7 kW electron beam, may then be used to melt a metal powder according to the two-dimensional pattern. The process may be repeated for the layers to build the desired three-dimensional structure.

Materials used to manufacture the downhole tool may include but are not limited to UV curable resins, ABS plastics, PEEK plastics, Teflon plastics, iron alloys and steels, aluminum alloys, copper alloys, titanium alloys, nickel alloys and cobalt alloys. The material may be any additive manufacturing material known to one having ordinary skill in the art, and manufacture of the downhole tool is not limited to a specific material.

After additive manufacturing is complete, the downhole tool may be finished using an abrasive process, such as sanding, sand blasting, bead blasting, and/or the like, to remove improper contours and/or improve surface finish at 108. The downhole tool may be inspected, such as, for example, to determine whether the downhole tool is void, porosity free, and/or ready for creation of sealing surfaces. Based on the inspection, a hot isostatic press may be used on the downhole tool so that the downhole tool is void, porosity free, and/or ready for creation of sealing surfaces.

At 110, complete parts may be machined using a computer numerical control (CNC) mill or lathe, and may be indexed using previously-referenced features, such as the datum features, to facilitate machining process. Threads, sealing surfaces, tight tolerance features, features requiring extraordinarily good surface finishes and/or any other feature that requires a machined surface, finish or feature may be created using this machining and/or the previously-referenced features. As a result, the downhole tool may be created using the positive aspects of additive manufacturing and the positive aspects of traditional subtractive manufacturing.

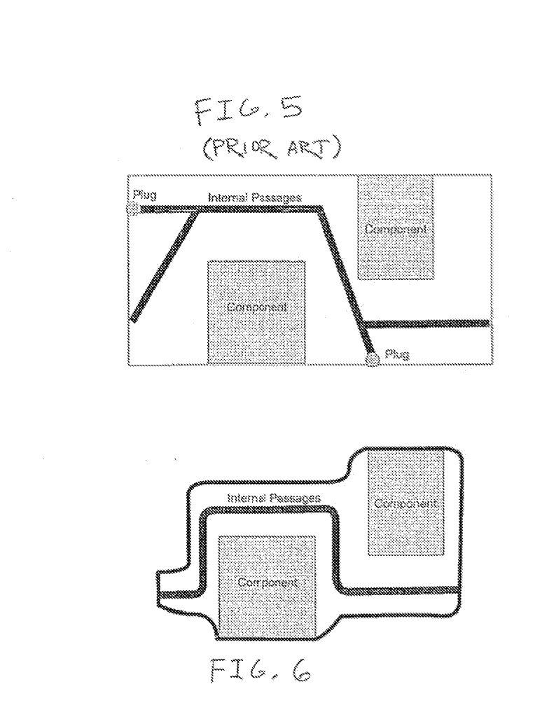

FIG. 5 generally illustrates a prior art downhole tool manufactured using traditional subtractive manufacturing, and FIG. 6 generally illustrates an example of a downhole tool manufactured according to one or more aspects of the present disclosure. As generally illustrated by FIGS. 5 and 6, the downhole tool manufactured according to one or more aspects of the present disclosure may have a smaller size, a smaller weight and/or a smaller volume relative to the prior art downhole tool manufactured using traditional subtractive manufacturing.

The preceding description has been presented with reference to present embodiments. Persons skilled in the art and technology to which this disclosure pertains will appreciate that alterations and changes in the described structures and methods of operation can be practiced without meaningfully departing from the principle and scope of the disclosure. Accordingly, the foregoing description should not be read as pertaining only to the precise structures described and shown in the accompanying drawings, but rather should be read as consistent with and as support for the following claims, which are to have their fullest and fairest scope.

What is claimed is:

1. A method for manufacturing a downhole component, comprising:
designing a component with a computer program, wherein the designing of the component generates a CAD file;
converting the CAD file to a STL file;
initiating manufacture of the downhole component using an additive manufacturing technique;
finishing the downhole component with the additive manufacturing technique.

2. The method according to claim 1, further comprising:
machining the finished downhole component.

3. The method according to claim 2, wherein the finishing the downhole component is performed using at least one of sanding, sand blasting and bead blasting.

4. The method according to claim 2, wherein the machining the finished downhole component is achieved by at least one of a CNC machine and a lathe.

5. The method according to claim 1, further comprising:
inspecting the downhole component after the finishing the downhole component with the additive manufacturing technique.

6. The method according to claim 1, wherein the initiating the manufacture of the downhole component using an additive manufacturing technique is through selective laser sintering.

7. The method according to claim 1, wherein the initiating the manufacture of the downhole component using an additive manufacturing technique is through fused deposition.

8. The method according to claim 1, wherein the initiating the manufacture of the downhole component using an additive manufacturing technique is through stereo lithography.

9. The method according to claim 1, wherein the initiating the manufacture of the downhole component using an additive manufacturing technique is through electron beam melting.
